(19) United States
(12) Patent Application Publication
(10) Pub. No.: US 2011/0112871 A1
(43) Pub. Date: May 12, 2011

(54) HEALTH CARE BENEFITS CLAIMS REVIEW AND RECOMMENDATION SYSTEMS AND METHODS

(75) Inventors: James Simonowski, Liberty Lake, WA (US); Rick Klingler, Liberty Lake, WA (US); John R. Christiansen, Seattle, WA (US)

(73) Assignee: J & F HOLDINGS, LLC, Sandpoint, ID (US)

(21) Appl. No.: 12/617,609

(22) Filed: Nov. 12, 2009

(51) Int. Cl. G06Q 40/00

(52) U.S. Cl. 705/4

(57) ABSTRACT

Systems and methods are provided herein that provide for health care pricing analysis and recommendation.

### FIELD

This disclosure relates generally to health care, and more specifically, to systems and methods for health care pricing analysis and recommendation systems and methods.

### BACKGROUND

Health care benefits are provided to a substantial portion of the United States population through health plans sponsored by employers, including public and private companies and governmental entities, and by other organizations and entities. Plans may administer health benefits themselves, or contract their administration to third parties that specialize in health benefits administration, which may be called “administrators” or “third party administrators.” A plan or administrator which is responsible for determination of the amount payable for a claim and authorization of its payment is a “payor.”

Health care benefits may be paid directly to individual plan members as reimbursement for covered healthcare goods and services, but are frequently paid directly to the health care providers which supply the goods and services. Payments to providers may be mediated through a variety of different mechanisms including direct payor/provider contracts, indirect contracts through healthcare provider networks and preferred provider organizations, and assignment of plan benefits rights by covered individuals to their providers.

Outside of certain governmental programs, prices for healthcare goods and services are not often published, made available, or agreed to by individuals or payors prior to the provision of the goods or services. Prices are frequently provided to payors only upon the presentation of claims for reimbursement of sums paid by the plan member for goods and services which have already been provided, or claims presented by the providers of such goods and services as assignees of the member's right to reimbursement.

Upon receipt of a claim for health benefits, a payor must typically determine first, whether the goods or services are covered by the plan; next, whether the plan is subject to a direct or indirect contract which establishes payment terms for goods and services provided by the provider; and if not, third, the terms for reimbursement for the goods and services under the provisions of the plan. In the absence of specific contractual terms, plan reimbursement provisions frequently limit reimbursement to amounts consistent with costs or charges for comparable goods and services in the applicable market. Such provisions are often referred to as “usual, customary and reasonable” (“UCR”) or “usual and customary (“U&C”) provisions, or by comparable terms.

The prices claimed by providers of many healthcare goods and services have been subject to consistent, material inflation. In the absence of an effective market system and mechanisms for agreement upon the prices of healthcare goods and services prior to the provision of care, many payors seek to manage inflationary healthcare costs through cost containment solutions, including contractual and network discounts, and UCR methodologies. Application of such solutions may result in payments substantially lower than those claimed by providers, though substantially higher than the average payment for comparable goods and services in the applicable market.

Plan provisions frequently include member rights to appeal adverse decisions about reimbursement of their claims, which may be pursued by providers as their assignees. Providers frequently pursue such appeals when the application of cost containment solutions results in payments lower than those claimed. Such appeals provide for the independent review and if appropriate redetermination of the initial claim payment decision.

### BRIEF DESCRIPTION OF THE DRAWINGS

The present invention will be described by way of exemplary embodiments but not limitations, illustrated in the accompanying drawings in which like references denote similar elements, and in which:

FIG. 1 is a pictorial diagram of a system of interconnected devices, in accordance with various embodiments.

FIG. 2 is a block diagram of a device that provides an exemplary operating environment for various embodiments.

FIG. 3 is a diagram illustrating the actions taken by a user device, an admin server, and an admin device in accordance with various embodiments.

FIG. 4 is a flow diagram illustrating a program recommendation routine in accordance with various embodiments.

FIG. 5 is a flow diagram illustrating another program recommendation routine in accordance with various embodiments.

FIG. 6 is a flow diagram illustrating an intake data score sub-routine in accordance with various embodiments.

FIG. 7 is a flow diagram illustrating another intake data score sub-routine in accordance with various embodiments.

FIG. 8 is a flow diagram illustrating a program recommendation sub-routine in accordance with various embodiments.

FIG. 9 is a flow diagram illustrating another program recommendation sub-routine in accordance with various embodiments.

FIG. 10 is a diagram illustrating the actions taken by an admin server, and a first and second web server in accordance with various embodiments.

FIG. 11 is a flow diagram illustrating a pricing analysis and recommendation routine in accordance with various embodiments.

FIG. 12 is a flow diagram illustrating a patient average reimbursement to provider calculation sub-routine in accordance with various embodiments.

FIG. 13 is a flow diagram illustrating an average provider charge sub-routine in accordance with various embodiments.

FIG. 14 is a flow diagram illustrating an average payment received by provider calculation sub-routine in accordance with various embodiments.

FIG. 15 is a diagram illustrating a pricing analysis and recommendation explanation matrix in accordance with various embodiments.

FIG. 16 is a diagram illustrating the actions taken by an admin server, and a user device in accordance with various embodiments.

FIG. 17 is a flow diagram illustrating a pricing analysis and recommendation routine in accordance with various embodiments.

FIG. 18 is a diagram illustrating the actions taken by an admin server, an appellant device, and a user device in accordance with various embodiments.

FIG. 19 is a diagram illustrating the actions taken by an admin server, an appellant device, and a user device in accordance with another embodiment.

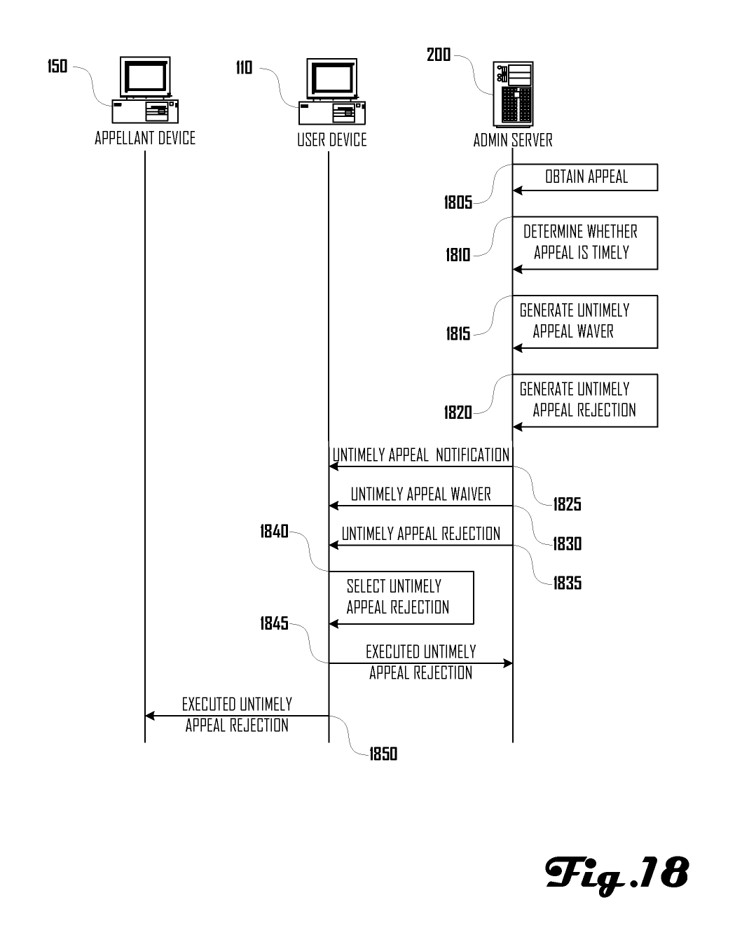

FIG. 18 is a diagram illustrating the actions taken by an admin server, an appellant device, and a user device in accordance with some embodiments.

FIG. 21 is a diagram illustrating the actions taken by an admin server, an appellant device, and a user device in accordance with various embodiments.

FIG. 22 is a flow diagram illustrating an appeal assessment and response routine in accordance with various embodiments.

FIG. 23 is a flow diagram illustrating an appeal issue assessment and response subroutine in accordance with various embodiments.

### DESCRIPTION

Illustrative embodiments presented herein include, but are not limited to, systems and methods for health care pricing analysis and recommendation, and in some exemplary embodiments U&C or UCR pricing analysis and recommendation. In some embodiments, U&C and UCR may be considered equivalent.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

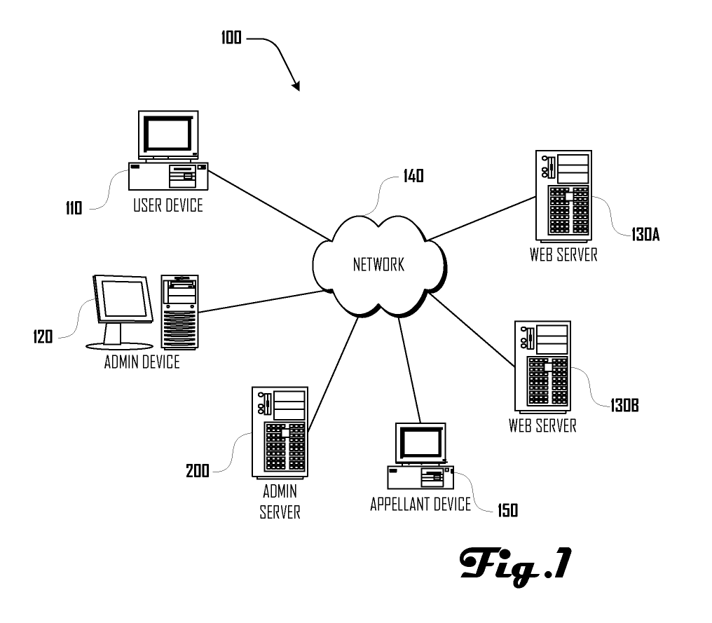

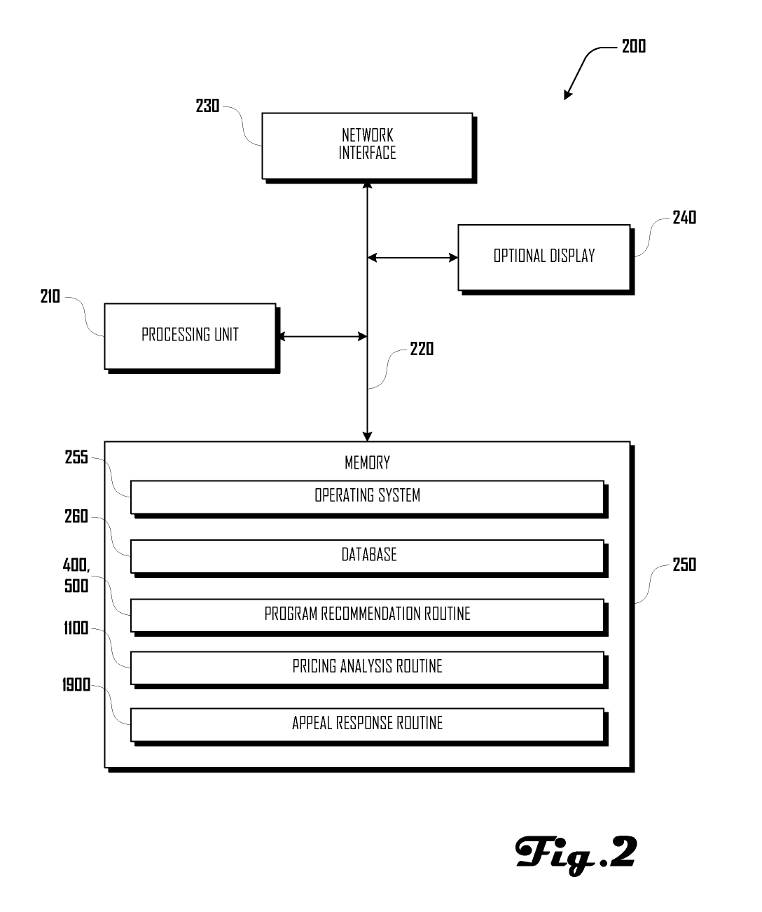

FIG. 1 is a pictorial diagram of a system of interconnected devices 100 in accordance with various embodiments. The system of interconnected devices 100 comprises a user device 110, an admin device 120 an admin server 200, a first web server 130A, a second web server 1308, and an appellant server 150, which are operationally connected via a network 140.

In various embodiments, the admin device 120 and the admin server 200 may be associated with a company that assists health care payors in pricing analysis and pricing recommendation of health care goods and services. In some embodiments, such health care goods and services may be dialysis services and related products and services.

The user device 110 may be associated with such payors, and in some embodiments there may be a plurality of user devices 110 each associated with one or more health care payor. The system of interconnected devices 100 as depicted in FIG. 1 is operable to allow a user to interact with a company providing health care pricing analysis and pricing recommendation services.

Additionally, the first and second web server 130A, 130B may be associated with various companies, governmental entities, local entities, state entities, individuals, and the like. In some embodiments, there may be a plurality of web servers 130.

In various embodiments, a web server 130 can be associated with a governmental entity such as the Securities and Exchange Commission, the Internal Revenue Service, a State tax authority, a State securities commission, and the like. In other embodiments, a web server 130 may be associated with a non-governmental entity providing information. In various examples, a web server 130 is operable to store records, which may be accessed by the admin server 200, admin device 120, user device 110, another web server 130, and the like. This may be desirable because records stored on a web server 130 may be utilized by such devices.

In various embodiments, the appellant server may be associated with an insurance agency, health care provider, governmental health care agency, health care agency, and the like.

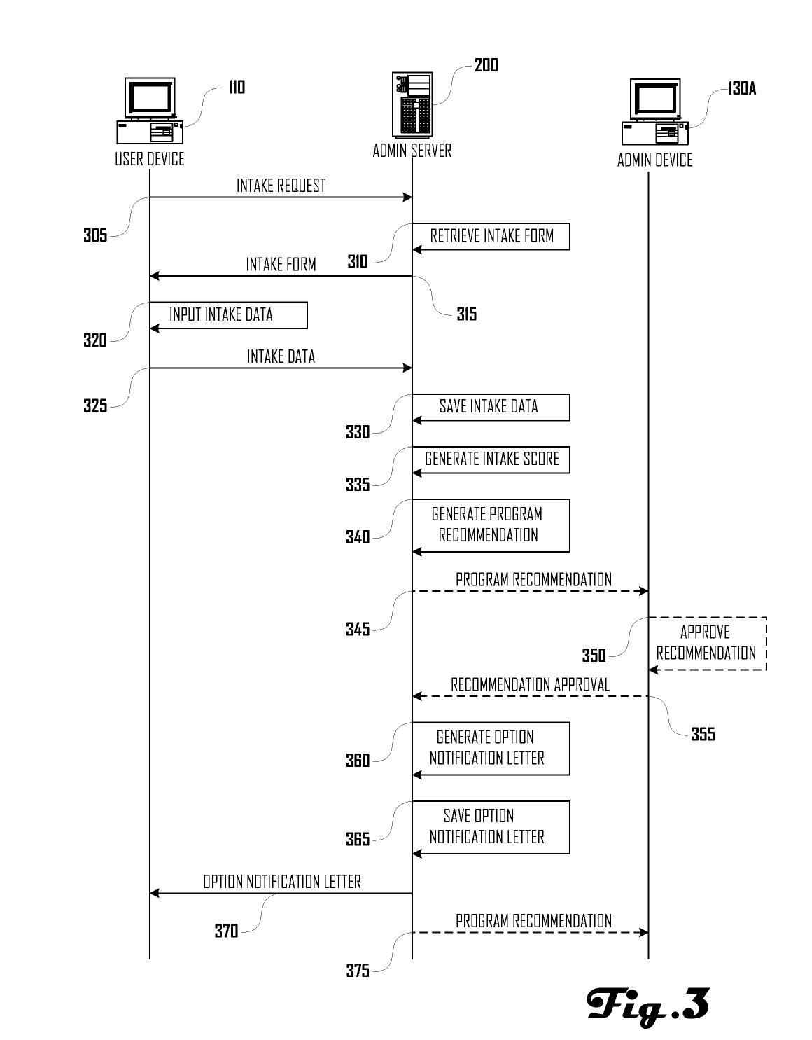

FIG. 2 illustrates several components of an exemplary admin server 200 for an embodiment. Those of ordinary skill in the art and others will appreciate that the admin server 200 may include many more components than those shown in FIG. 2. However, it is not necessary that all of these generally conventional components be shown in order to disclose an enabling embodiment for practicing the embodiments described herein. As shown in FIG. 2, the admin server 200 includes a network interface 230 for connecting to remote devices (not shown). The network interface 230 may be a network interface designed to support a local area network (“LAN”), wireless local area network (“WLAN”), personal area network (“PAN”), Worldwide Interoperability for Microwave Access (“WiMax”), telephone network, pager network, powerline connection, serial bus, universal serial bus (“USB”) wireless connection, or the like. The network interface 230 includes the necessary circuitry, driver and/or transceiver for such a connection and is constructed for use with the appropriate protocols for such a connection.

The admin server 200 also includes a processing unit 210, an optional display 240 and a memory 250, all interconnected along with the network interface 230 via a bus 220. Those of ordinary skill in the art and others will appreciate that the display 240 may not be necessary in all forms of computing devices and, accordingly, is an optional component. The memory 250 generally comprises random access memory (“RAM”), a read only memory (“ROM”) and a permanent mass storage device, such as a disk drive, flash RAM, or the like. The memory 250 stores the program code necessary for a program recommendation routine 400, 500, a pricing analysis and recommendation routine 1100, and an appeal response routine 1900. Additionally, the memory 250 stores an operating system 255 and a database 260.

It will be appreciated that the software components may be loaded from a computer readable medium into memory 250 of the admin server 200 using a drive mechanism (not shown) or network mechanism (not shown) associated with the computer readable medium, such as a floppy, tape, digital video disc (DVD)/CD-ROM drive, flash RAM, network interface card, or the like.

Although an exemplary admin server 200 has been described that generally conforms to a conventional general-purpose computing device, those of ordinary skill in the art will appreciate that a admin server 200 may be any of a great number of devices capable of functioning as a device, server or operating environment that is within the spirit or scope of the embodiments described herein or can perform at least one function of the embodiments described herein.

In one exemplary embodiment, an admin device 120, a user device 100 or a web server 130 can configure or interact with the admin server 200 using a graphical user interface. An example of a graphical user interface is an interactive web page, e.g., in HTML (HyperText Markup Language), Flash, JavaScript, VBScript, JScript, ASP.NET, PHP (HTML Preprocessor) or XHTML (eXtensible HyperText Markup Language) form, or the like. Resultantly, since users are generally familiar with the user interfaces of web pages, including sophisticated web pages such as Flash-enabled web pages from Macromedia, Incorporated of San Francisco, Calif., consumption of peer to peer device services using a web page based graphical user interface on a peer to admin server 200 (e.g., displayed on the peer to peer display 240) may be made familiar and user friendly.

The following FIGS. 3-9 depict actions, routines, and sub-routines relating to case intake and program recommendation. For example, in various embodiments, intake data is obtained from a client, which is scored and used to provide an indication of whether one or more pricing analysis and pricing recommendation program should be recommended to the client.

There may be a plurality of pricing analysis and recommendation programs that relate to health care. In some embodiments, various programs may include a UCR analysis and recommendation, U&C analysis and recommendation, a direct contract, a single patient program, a hemodialysis program, a home hemodialysis program, a network discount program, a Medicare program, and the like. In various embodiments, such programs may provide a reduction in the amounts payable for health care goods and services from the amounts claimed by providers. In some embodiments, such programs may provide a discount for dialysis services in relation to cost being currently paid by the client.

In some embodiments, factors in addition to potential cost savings may be relevant to a program recommendation or pricing analysis. Accordingly, client intake responses can be used to determine whether a given payor or plan member would benefit from a given program, whether the payor or plan member would be successful in such a program, and whether any potential risks are outweighed by the potential benefits.

For example, a usual, customary and reasonable program may provide the most savings for a client, but may also create the greatest risk of appeal by a health care provider. Accordingly, it may be beneficial to determine whether the client is risk adverse or would be negatively affected by the appeal process relating to usual, customary and reasonable program appeal.

Additionally, other factors may be considered in client intake which would determine whether a program would be beneficial to the client. For example, such factors may include, location of current one or more treatment facility, availability of health care providers, insurance provider, insurance claim type, current treatment schedule, health prognosis, amount previously paid or claimed for treatments currently, risk adversity, risk tolerance to an appeal, availability of stop-loss insurance, plan reserves, support for cost re-pricing provided by plan language, type of goods and services required, anticipated future treatment needs, inflation rates, payor preference, and the like.

In some embodiments, an intake score may be provided in relation to each program or one score may be provided. In embodiments where a single score is provided, the programs may be in a hierarchy such that certain programs are qualified for at a defined score threshold. Each program may have a different score threshold or one or more program may have the same score threshold.

FIG. 3 is a diagram illustrating the actions taken by a user device 110 and admin server 200 and an admin device 130A. The actions begin where an intake request is sent 305 to the admin server 200 where an intake form is retrieved 310 and the intake form is sent 315 to the unit device 110. Intake data is input 320 and intake data is sent 325 to the admin server 200.

For example, intake data may be requested 305, sent 315, and obtained 325 via a graphic user interface such as a webpage. Such a webpage may allow a user to input 320 intake data and send 325 data to the admin server 200. In other embodiments, intake data may be requested 305, sent 315, and obtained 325 via e-mail, facsimile, text message, postal mail, and the like.

Returning to the actions, intake data is saved 330 and an intake score is generated 335. A program recommendation is generated 340, and in an optional step, a program recommendation is sent 345 to the admin device 130A where the recommendation is approved 350 and the recommendation approval is sent 355 to the admin server 200.

For example, there may be a plurality of programs that are available to a client and one or more generated 335 intake score may be used to determine which program or programs should be recommended to the client. A program recommendation can be generated that provides a recommendation of at least one program to a client, and such a recommendation may include an explanation of why such a recommendation is being made. In some embodiments, it may be desirable to allow a generated 340 program recommendation to be reviewed by an administrator, and therefore the program recommendation may be sent 345 to the admin device 130A in some embodiments.

An option notification letter is generated 360 and the option notification letter is saved 365. The option notification letter is sent 370 to the user device 110 and in an optional step a program recommendation is sent 375 to the admin device 200.

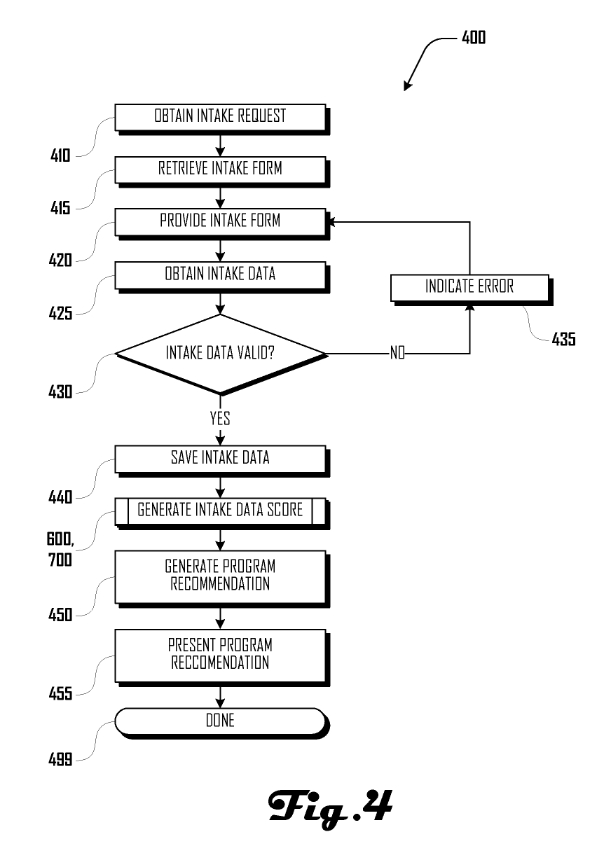

FIG. 4 is a flow diagram illustrating a program recommendation routine 400 in accordance with various embodiments. In block 410, an intake request is obtained and in block 415 the intake form is retrieved. In block 420, the intake form is provided and in block 425 intake data is obtained. As described above, in various embodiments, intake forms and form data can be sent, received, and/or obtained via a website.

In decision block 430 a determination is made whether intake data is valid. If intake data is not valid the program recommendation routine 400 continues to block 435 where an error is indicated and cycles back to block 420 where the intake form is again provided. However, if intake data is valid, the program recommendation routine 400 continues to block 440 where intake data is saved.

The program recommendation routine 400 continues to block 600, 700 where an intake data score is generated and the program recommendation routine 400 continues to block 450 where a program recommendation is generated. In block 455 the program recommendation is presented and the routine 400 ends in block 499.

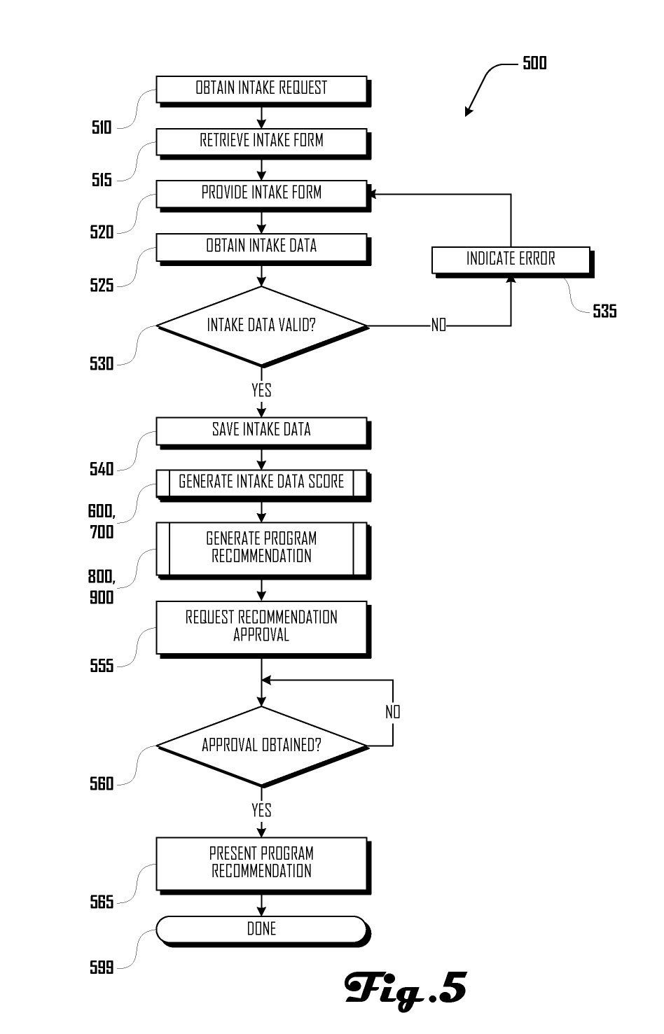

FIG. 5 is a flow diagram illustrating another program recommendation routine 500 in accordance with various embodiments. The program recommendation routine 500 begins in block 510 where an intake request is obtained and continues to block 515 where intake form is retrieved. In block 520 intake form is provided and in block 525 intake data is obtained.

In decision block 530 a determination is made whether intake data is valid. If intake data is not valid, the program recommendation routine 500 continues to block 535 where an error is indicated and cycles back to block 520 where intake form is again provided.

However, if intake data is valid, the program recommendation routine 500 continues to block 540 where intake data is saved. In subroutine block 600, 700 intake data score is generated and the program recommendation routine 500 continues to subroutine block 800, 900 where a program recommendation is generated.

The program recommendation routine 500 continues to block 555 where a recommendation approval is requested. In decision block 560 a determination is made whether an approval is obtained. If an approval is not obtained, the program recommendation routine 500 cycles back to decision block 560 where a determination is again made whether approval is obtained.

However, if approval is obtained, the program recommendation routine continues to block 565 where the program recommendation is presented. The program recommendation routine 500 ends in block 599.

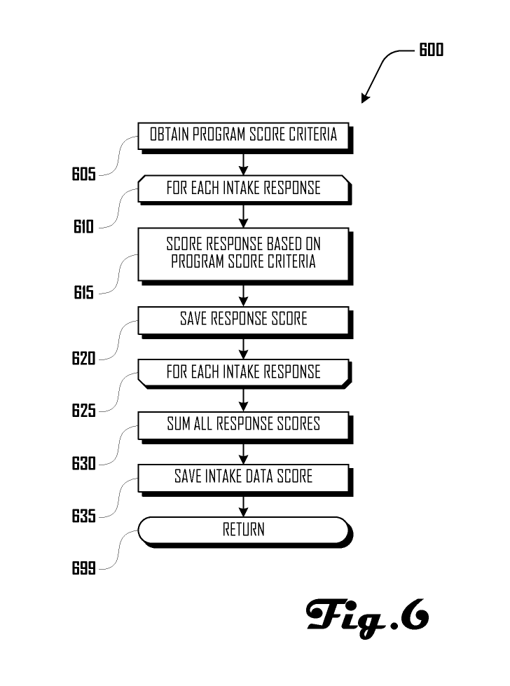

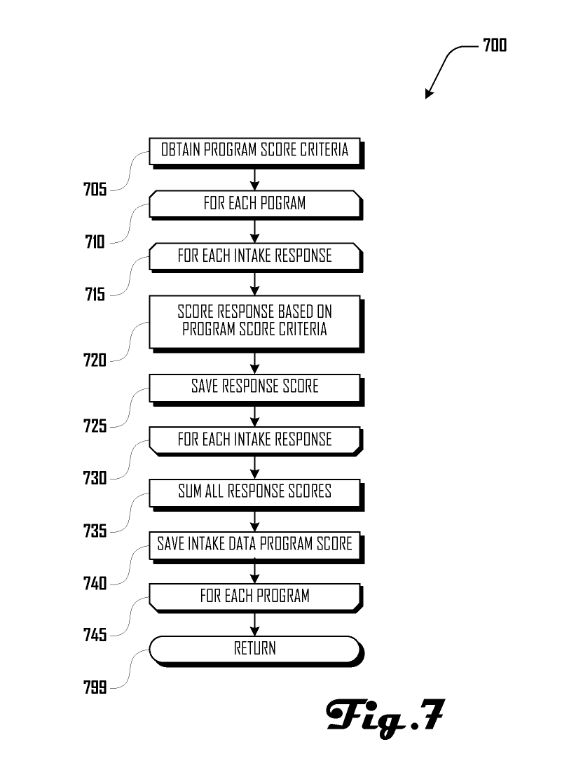

FIG. 6 is an intake data score subroutine 600 in accordance with various embodiments. The intake data score subroutine 600 begins in block 605 where program score criteria are obtained. In looping block 610, a loop is begun for each intake response. In block 615 a response based on program score criteria is scored and in block 620 response score is saved. Looping block 625 terminates the loop for each intake response. In block 630, all response scores are summed and in block 635 intake data score is saved. The intake data score subroutine 600 returns to its calling routine in block 699.

FIG. 7 is a flow diagram illustrating another intake data score subroutine 700 in accordance with various embodiments. The intake data score subroutine 700 begins in block 705 where program score criteria are obtained. In looping block 710 a loop begins for each program and in looping block 715 a loop begins for each intake response. In block 720 a response based on program score criteria is scored and in block 725 response score is saved. Looping block 730 ends the loop for each intake response. In block 735 all response scores are summed and in block 740 intake data program score is saved. Looping block 745 ends the loop for each program and the intake data score subroutine 700 returns to its calling routine in block 799.

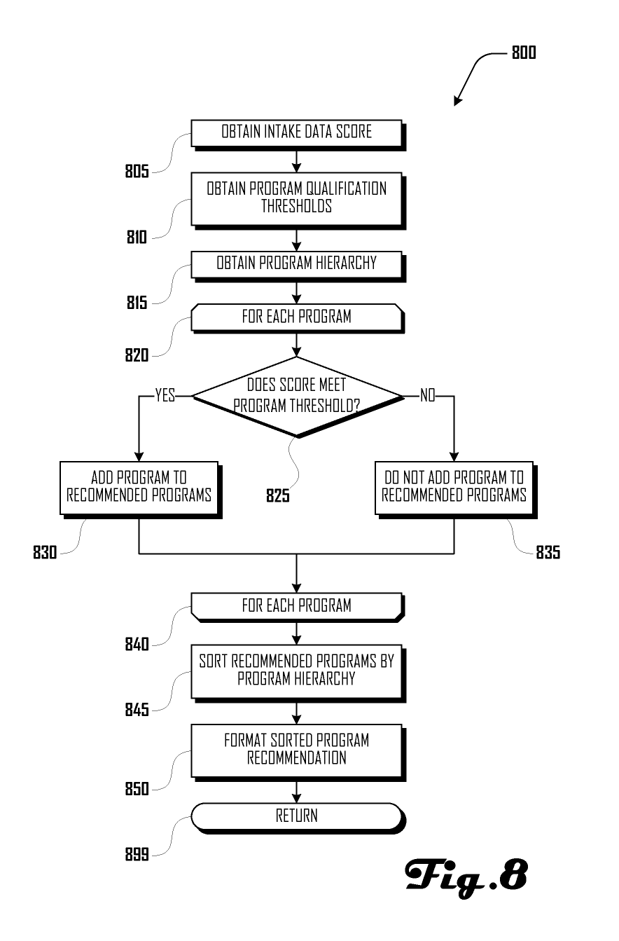

FIG. 8 is a flow diagram illustrating a program recommendation subroutine 800 in accordance with various embodiments. The program recommendation subroutine 800 begins in block 805 where intake data score is obtained and continues to block 810 where program qualification thresholds are obtained. In block 815 program hierarchy is obtained. Looping block 820 begins a loop for each program. In decision block 825, a determination is made whether the score meets the program threshold. If score does not meet the program threshold, the program recommendation subroutine continues to block 835 where the program is not added to the recommended program list.

However, if the score does meet the program threshold, the program recommendation subroutine 800 continues to block 830 where the program is added to the recommended program list. Looping block 840 ends the loop for each program and in block 845 recommended programs are sorted by program hierarchy. In block 850 sorted program recommendations are formatted and the program recommendation subroutine 800 returns to its calling routine in block 899.

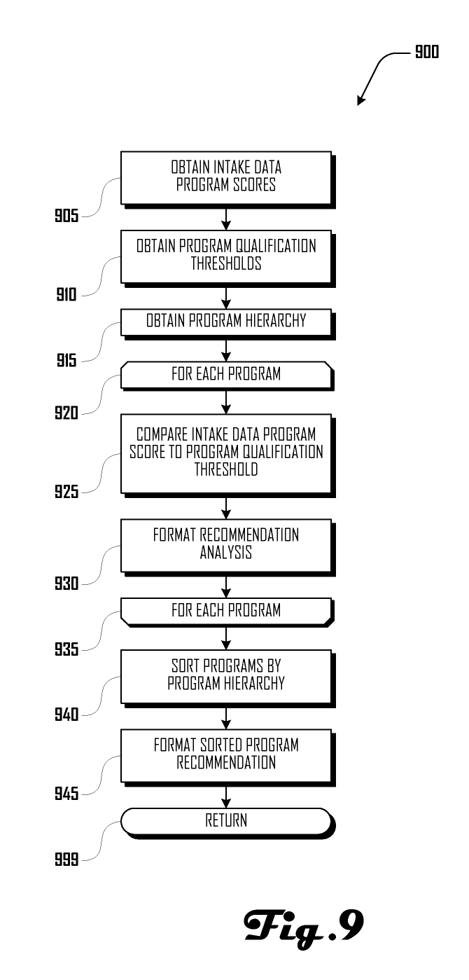

FIG. 9 is a flow diagram illustrating another program recommendation subroutine 900 in accordance with various embodiments. The program recommendation subroutine 900 begins in block 905 where intake data program scores are obtained. In block 910 program qualification thresholds are obtained and in block 915 program hierarchy is obtained. Looping block 920 begins a loop for each program. In block 925 intake data program score is compared to program qualification threshold and in block 930 recommendation analysis is formatted. Looping block 935 ends the loop for each program. In block 940, programs are sorted by program hierarchy and in block 945 the sorted program recommendation is formatted and the program recommendation subroutine 900 returns to its calling routine in block 999.

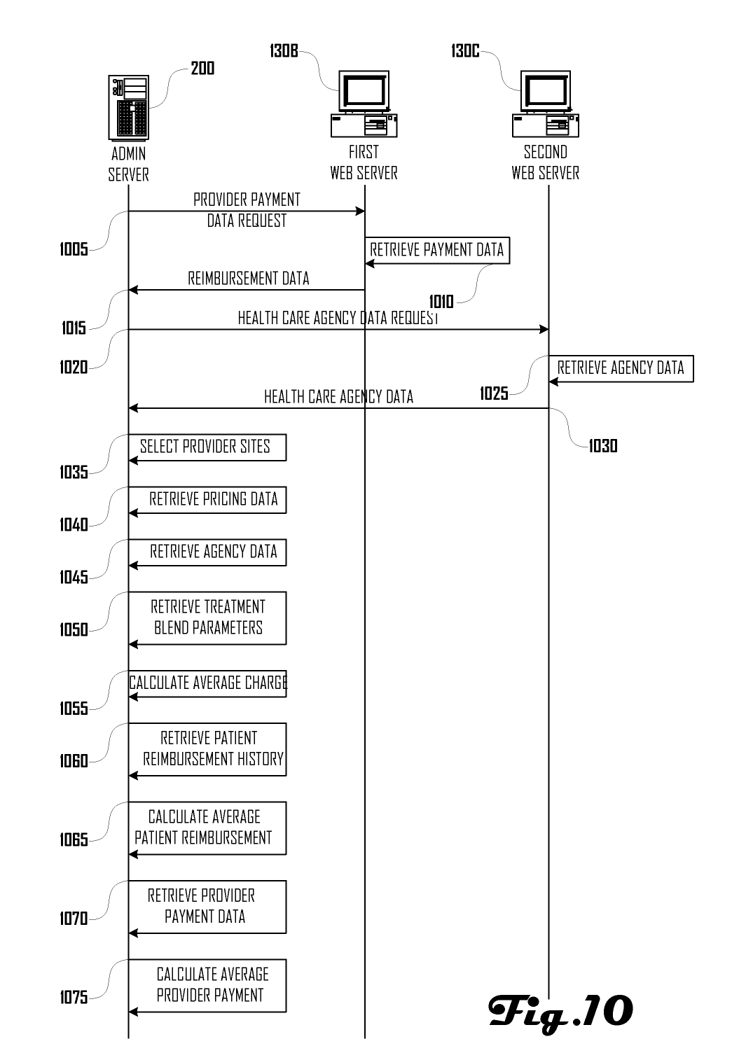

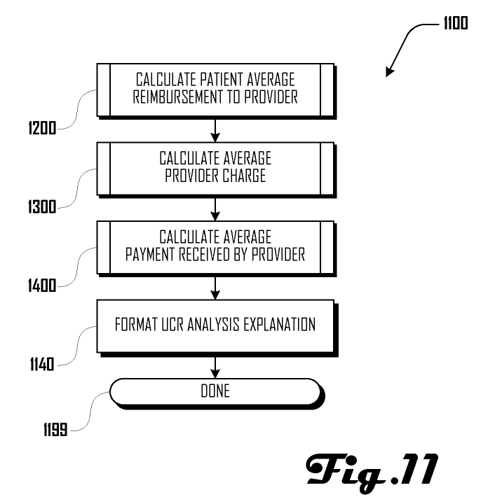

FIGS. 10-14 depict actions and routines that relate to cost analysis and recommendation for reimbursements and/or payments. For example, a payor or plan member may receive a bill, statement, quote or the like, any or all of which may constitute all or part of a claim and which indicates an amount that the payor or plan member is being requested to pay or that the payor or plan member will be requested to pay for health care services or products, and the following embodiments relate to determining an appropriate payment for the health care services or products. In one exemplary embodiment, health care services can be dialysis treatments, and re-pricing can be performed based on a usual, customary and reasonable re-pricing program.

FIG. 10 is a diagram illustrating the actions taken by an admin server 200 and a first and second web server 1308, 130C in accordance with various embodiments. In some embodiments, the first web server 1308 can be a Securities and Exchange Commission server or other server where financial filings, such as 10Q, or the like, are obtainable. In other embodiments, the second web server 130C can be associated with a governmental agency. In further embodiments, the second web server 130C can be a Medicare website, Medicare server, or the like wherein information relating to Medicare reimbursements for various treatments or health care goods can be obtained.

Turning to FIG. 10, the actions begin where a provider payment data request is sent 1005 to the first web server 1308 where payment data is retrieved 1010 and reimbursement data is sent 1015 to the admin server 200. A health care agency data request is sent 1020 to the second web server 130C where health care agency data is retrieved 1025, health care agency data is sent 1030 to the admin server 200.

As described herein, reimbursement data may relate to the amount that a health care provider actually obtains for goods and/or services when the provider requests payment for such services. In various embodiments, such data may be obtained via SEC 10Q filing, or from various other sources. In further embodiments, such information can be estimated.

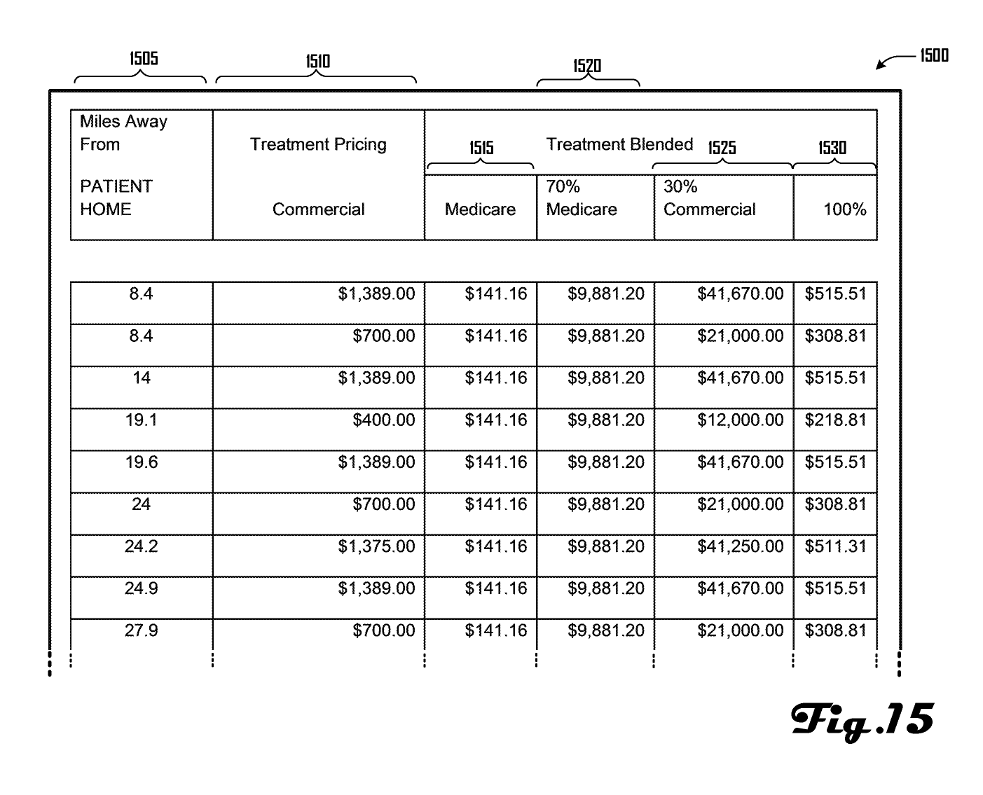

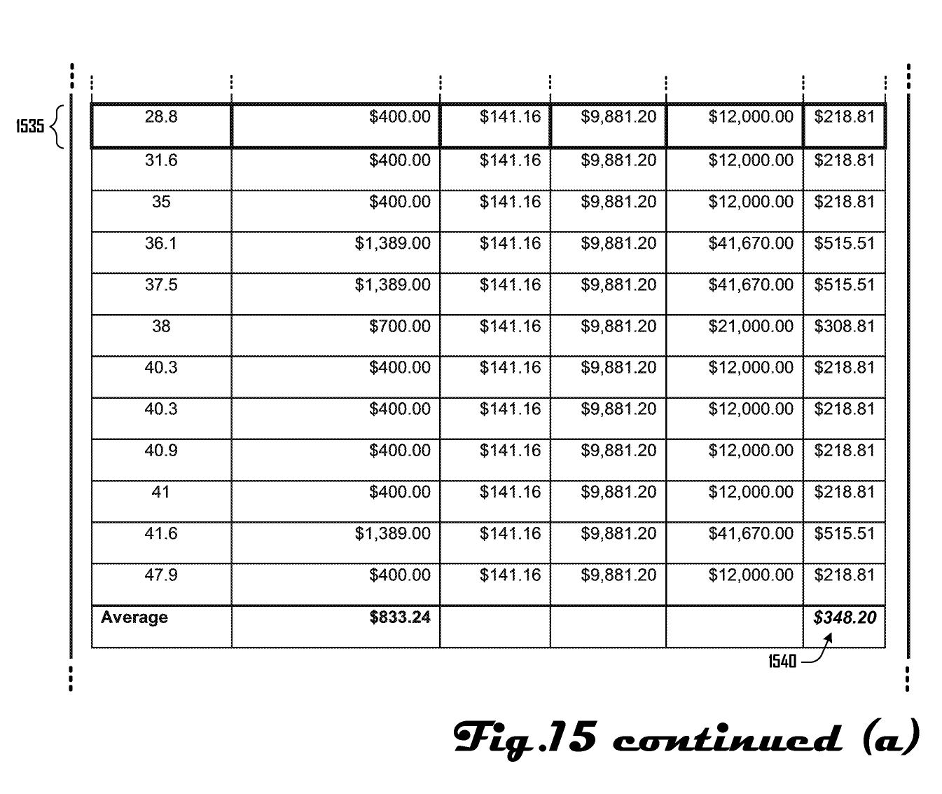

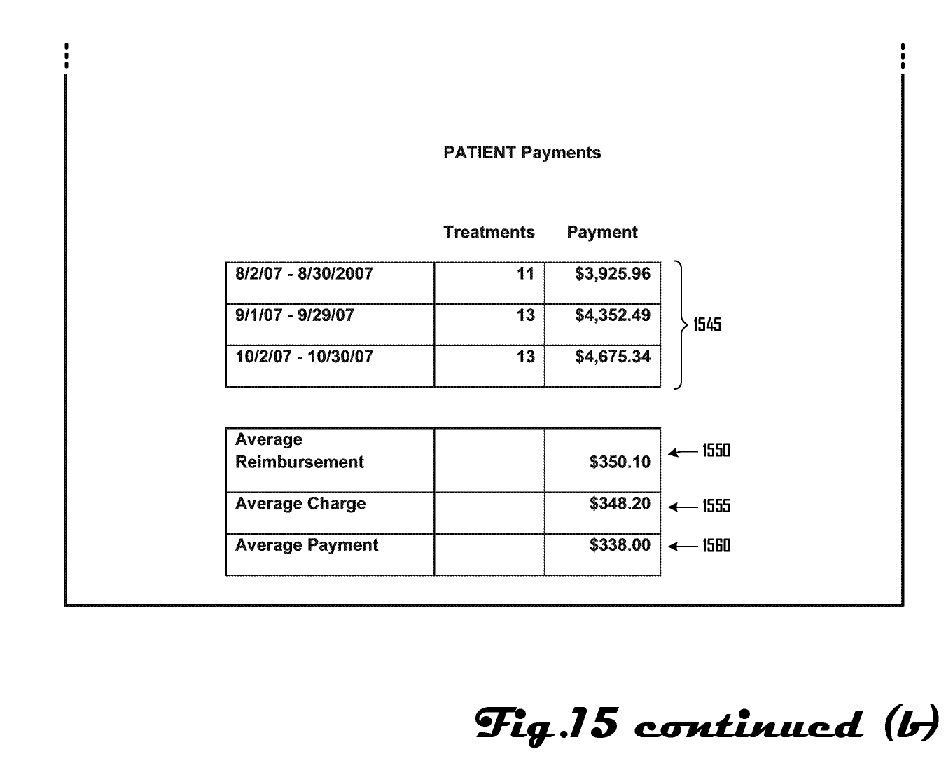

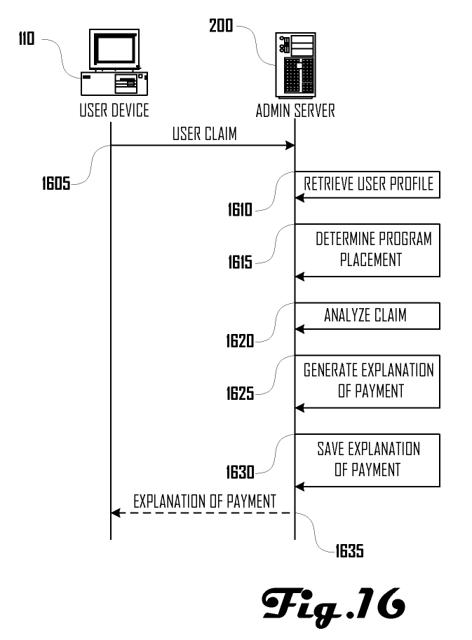

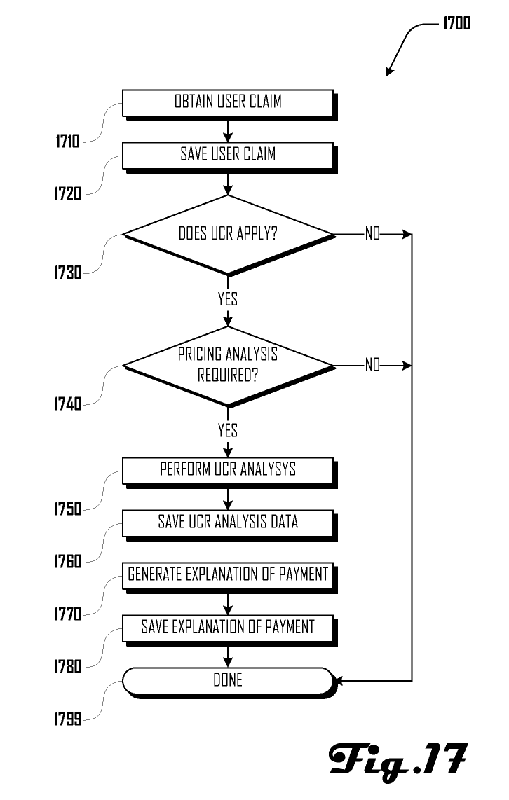

Provider sites are selected 1035 and pricing data is retrieved 1040. Health care agency data is retrieved 1045 and treatment blend parameters are retrieved 1050. Average charge is calculated 1055 and patient reimbursement history is retrieved 1060. Average patient reimbursement is calculated 1065 and provider payment data is retrieved 1070. Average provider payment is calculated 1075. In some embodiments, this information can be presented in a form such as depicted in FIG. 15. In some embodiments, health care agency data can comprise data from a governmental agency such as Medicare.

Regarding facility and provider selection, a facility can be a location where a health care provider provides a given health care good or service. For example, there may be a plurality of companies or organizations that provide goods and services and each company or organization may have a plurality of locations where they provide such goods and services.

In various embodiments, providers and/or provider facilities can be selected based on various criteria. For example, criteria may correspond or relate to a facility and provider that is, has or will provide goods and/or services to an individual plan member covered by a plan whose benefits are administered. Additionally, provider site selection can be made so as to create a set of representative providers in a given geographic market. In one example, providers can be selected that are within a certain radius of a provider location that is providing comparable services.

FIG. 11 is a flow diagram illustrating a health care price analysis and recommendation routine 1100 in accordance with various embodiments. The price analysis and recommendation routine 1100 begins in subroutine block 1200 where patient average reimbursement to provider is calculated. The price analysis and recommendation routine 1100 continues to subroutine block 1300 where average provider charge is calculated and in subroutine block 1400 the average payment received by provider is calculated. In block 1140, UCR re-pricing explanation is formatted and the re-pricing explanation routine ends in block 1199.

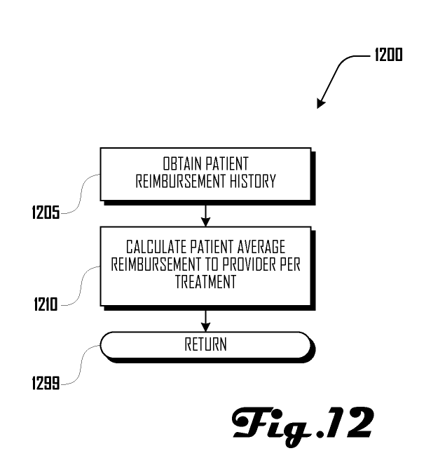

FIG. 12 is a flow diagram illustrating a patient average reimbursement to provider calculation subroutine 1200 in accordance with various embodiments. The patient average reimbursement to provider calculation subroutine 1200 begins in block 1205 where patient reimbursement history is obtained and in block 1210 patient average reimbursement to provider per treatment is calculated. The patient average reimbursement to provider calculation subroutine 1200 returns to its calling routine in block 1299.

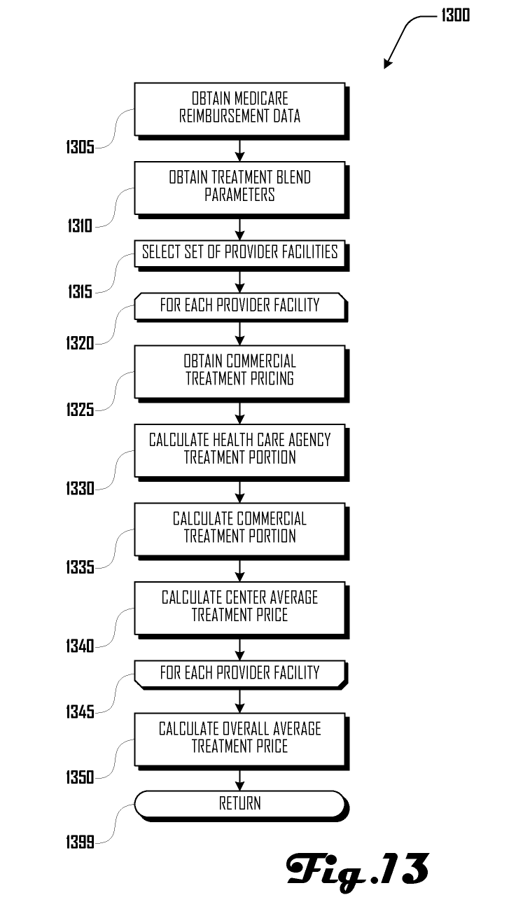

FIG. 13 is a flow diagram illustrating an average provider charge subroutine 1300 in accordance with various embodiments. The average provider charge subroutine 1300 begins in block 1305 where health care agency reimbursement data is obtained and in block 1310 treatment blend parameters are obtained. In some embodiments, such health care agency reimbursement data may be Medicare data. In block 1315 a set of provider centers is selected. Looping block 1320 begins a loop for each provider facility. In block 1325 commercial treatment pricing is obtained and in block 1330 health care agency treatment portion is calculated. For example, in one embodiment, health care agency treatment portion may relate to an amount paid by Medicare.

In block 1335 commercial treatment portion is calculated and in block 1340 center average treatment price is calculated. Looping block 1345 ends the loop for each provider facility. In block 1350 average overall treatment price is calculated and the average provider charge subroutine 1300 returns to its calling routine in block 1399.

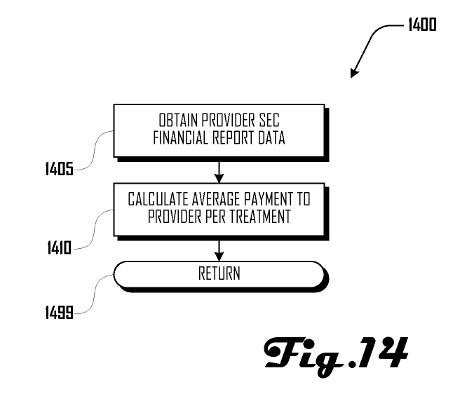

FIG. 14 is a flow diagram illustrating an average payment received by provider calculation subroutine 1400 in accordance with various embodiments. The average payment received by provider calculation subroutine 1400 begins in block 1405 where provided financial report data is obtained and in block 1410 average payment to provider per treatment is calculated. In various embodiments, financial report data may comprise data from an SEC filing. The average payment received by provider calculation subroutine 1400 returns to its calling routine in block 1499.

FIG. 15 depicts a price analysis and recommendation presentation 1500 in accordance with one embodiment. The price analysis and recommendation presentation 1500 comprises a distance column 1505, a commercial treatment pricing column 1510, a health care agency pricing column 1515, a health care agency blend column 1520, a commercial blend column 1525, and a blended average price column 1530. Additionally, there is a plurality of rows, which each present a different selected provider site. In some embodiments, the health care agency may be Medicare.

Also, there is a row that depicts the client's current provider facility in a client provider site row 1535. The average of the blended average price column 1530 is represented in the overall blended average field 1540. Additionally, there is a patient payment history field 1545 that depicts payments made by a payor for health care goods and/or services. There is also an average reimbursement field 1550, and average charge field 1555, and an average payment field 1560.

As shown in FIG. 15, the client provider row 1535 depicts data regarding the health care provider that a patient may be currently receiving treatment from. The distance column 1505 shows that the client's present provider is 28.8 miles away from the patient's home.

The remaining rows represent providers that have been selected to represent the market around the patient's present provider and/or the patient's residence. In some embodiments, representative providers can be selected based on distance from the patient's residence, distance from the client's current provider, a combination thereof, and the like.

As shown here, provider distance ranges from 8.4 miles to 47.9 miles. However, in some embodiments, distance from patient residence or current client provider can be within a greater range or a smaller range. For example, there may be a great number of representative health care providers in a metropolitan area, and therefore a smaller range of distance may be required to obtain a representative market perspective. In another example, there may be few representative health care providers in a rural area, and therefore a larger range of distance may be required to obtain a representative market perspective.

In various embodiments, commercial treatment pricing shown in the commercial treatment pricing column 1510 can be obtained by contacting the selected provider or by obtaining a price list from the provider. Additionally, health care agency reimbursement data as shown in the health care agency pricing column 1515 can be obtained from public records, from client billing statements, and the like.

Treatment blend parameters can be obtained based on data from one or more provider that indicated what percentage of business comes from health care agency patients or commercial patients. For example, a health care agency may be Medicare. As shown in FIG. 15, commercial pricing of health care goods and services may be much greater than health care agency pricing for comparable goods and/or services, which may be due to the fact that a given health care agency has historically been able to define a reimbursement price for such services, whereas commercial pricing is subject to different market conditions that allow providers to claim or charge a higher price.

The health care agency and commercial blend portions are defined here as being 70% health care agency and 30% commercial pricing. Such blend portions represent the portion of business that provider receives that is from health care agency patients and from commercial patients. In some embodiments, these blend proportions may be different, which may be based on local market conditions, national market conditions, a set of selected providers, and the like. Additionally, in some embodiments, blend proportions may be different for each selected provider or for groups of selected providers.

Accordingly, the health care agency blend column 1520 represents the pricing that is proportioned to 70 representative health care agency patients. Similarly, the commercial blend column 1525 represents the pricing that is proportioned to 30 representative commercial paying patients. The blended price column 1530 represents the blended price that would be paid by a theoretical blended single patient.

In various embodiments, the calculations described herein may be desirable because they represent a UCR price represents a reasonable and appropriate price for services under specified plan language. Given that health care agency patients may make up a large portion of the overall business obtained by providers, a UCR price would not simply be a typical commercial charge or a typical health care agency charge, but a blend of the two. In some embodiments, there may be three or more pricing types that can be blended to determine a blended price.

The average reimbursement field 1550 may represent an average reimbursement historically paid by a client under a UCR program, which is the average payment based on the patient payment history field 1545. The average charge field 1555 may correspond to the data in the overall blended average field 1540. The average payment field 1560 may correspond to the average payment that is actually obtained from patients. As shown here, this amount may be lower than prices claimed because some clients may not pay, the health care provider may provide rebates, and the like.

In various embodiments, it may be desirable to indicate that the average reimbursement of the payor shown in the average reimbursement field 1550 is greater than the average charge and average payment depicted in the average charge field 1555 and average payment field 1560, based upon factors affecting quality and inflation rates. Such an indication would suggest that the reimbursement paid by the payor at issue is more than UCR payment for similar services in the same market.

In further embodiments, such a market analysis and presentation can be applied where a client does not have a payment history with a health care provider but it is instead desired to determine a payment that should be made to a new provider under a usual customary and reasonable payment program. Accordingly, the patient payment field 1545 and average reimbursement field 1550 may be absent. Such fields may be replaced with a field that indicates a proposed payment for health care services based on determined average charge and average payment.

In various embodiments, it may be desirable to present a proposed payment that is greater than both the determined average charge and average payment. In such a case, the greater proposed payment may be based on factors differentiating the proposed payment from the expected UCR payment based upon factors adding value such as greater services quality as shown by provider accreditation or quality data, uncommon complexity of treatment required, inflation factors, and the like.

The following FIGS. 16 and 17 depict actions and routines related to generating an explanation of payment for health care services. For example, a user can obtain a first claim from a health care provider, or may obtain a claim from a health care provider that the user already has a history with. UCR analysis can be performed based on the claim and a recommendation for payment may be generated.

FIG. 16 is a diagram illustrating the actions taken by an admin server 200 and a user device 110 in accordance with various embodiments. The actions begin where a user claim is sent 1605 to the admin server 200. A user profile is retrieved 1610 and program placement is determined 1615. The claim is analyzed 1620 and a recommendation for payment is generated 1625. The recommendation for payment is saved 1630, and in an optional step, the recommendation for payment is sent 1635 to the user device 110.

FIG. 17 is a flow diagram illustrating a pricing analysis and recommendation routine 1700 in accordance with various embodiments. The pricing analysis and recommendation routine 1700 begins in block 1710 where a user claim is obtained and in block 1720 the user claim is saved. In decision block 1730 a determination is made whether UCR applies. If UCR does not apply, the pricing analysis and recommendation routine ends in block 1799.

However, if UCR does apply, the pricing analysis and recommendation routine 1700 continues to decision block 1740 where a determination is made whether pricing analysis and recommendation is required. If pricing analysis and recommendation is not required, the claim pricing analysis and recommendation routine 1700 continues to block 1799 where the pricing analysis and recommendation routine 1700 ends. However, if pricing analysis and recommendation is required the claim pricing analysis and recommendation routine 1700 continues to block 1750 where pricing analysis and recommendation is performed, and in block 1760 pricing analysis and recommendation data is saved. In block 1770 a recommendation is generated and in block 1780 the recommendation is saved. The pricing analysis and recommendation routine ends in block 1799.

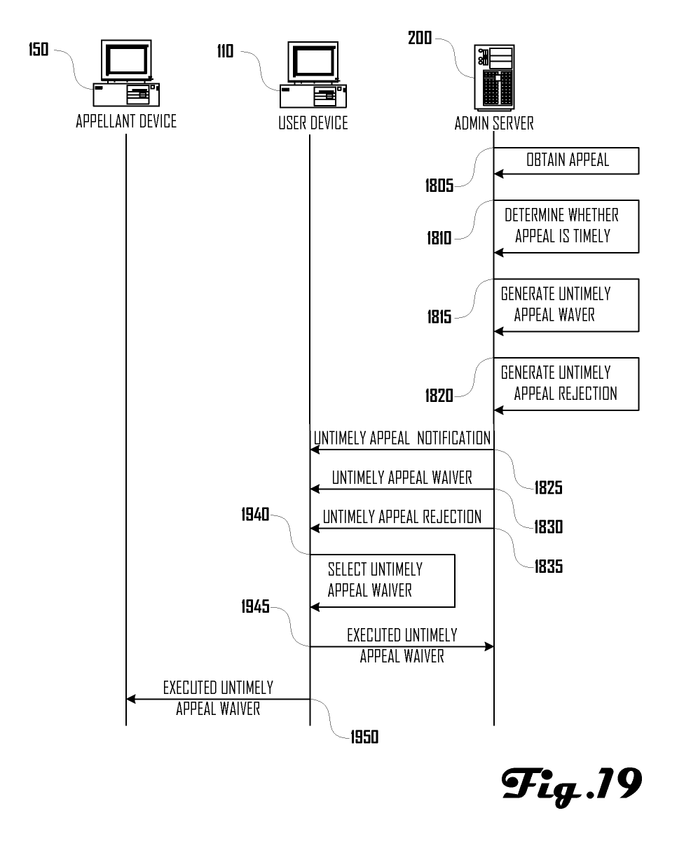

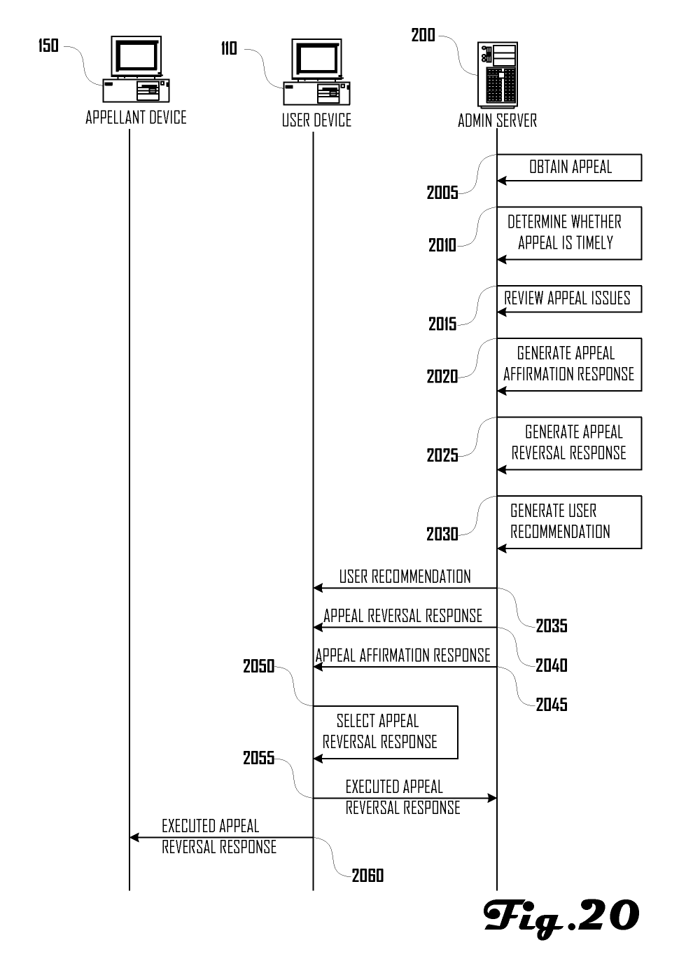

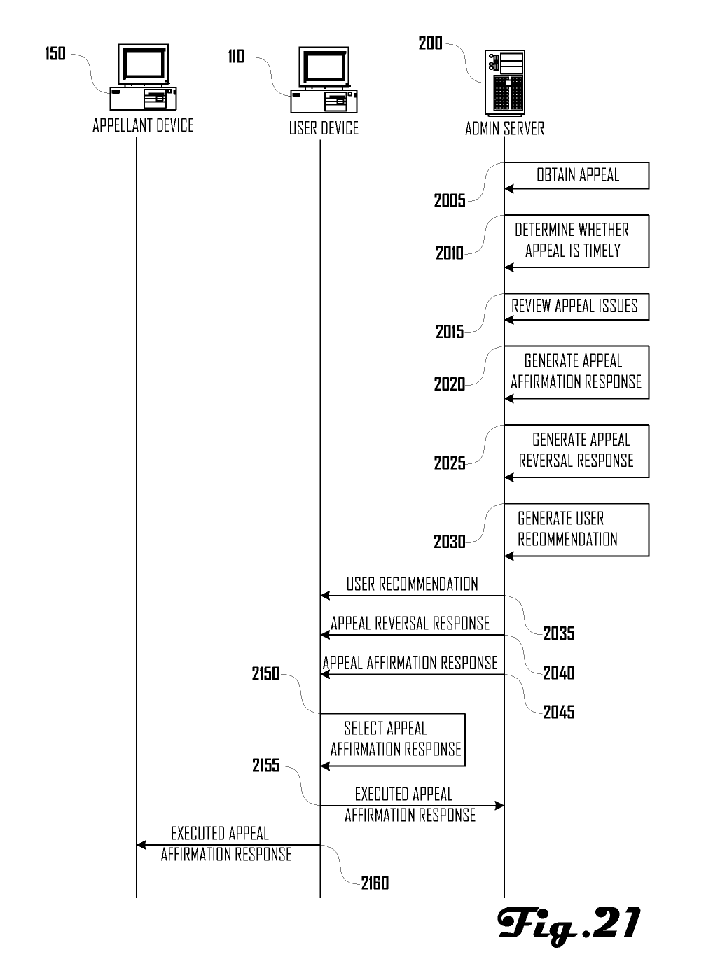

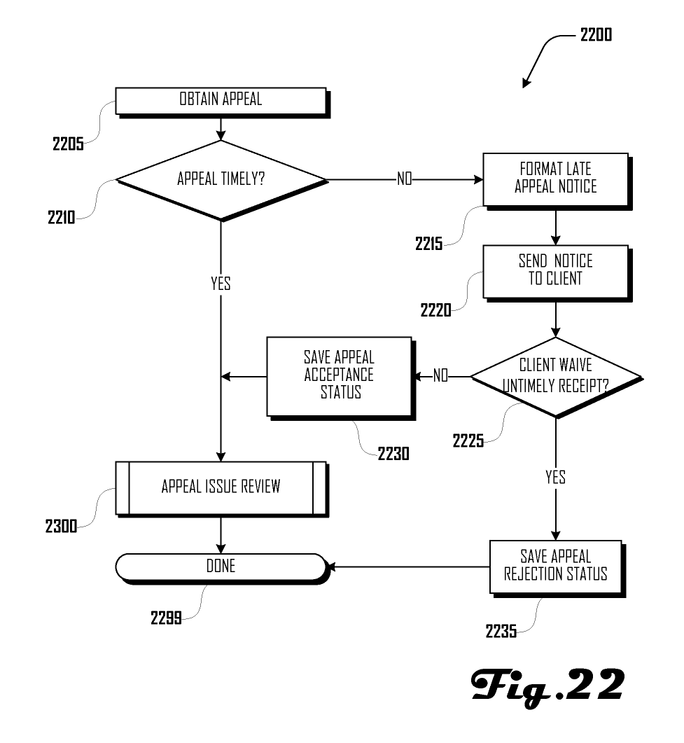

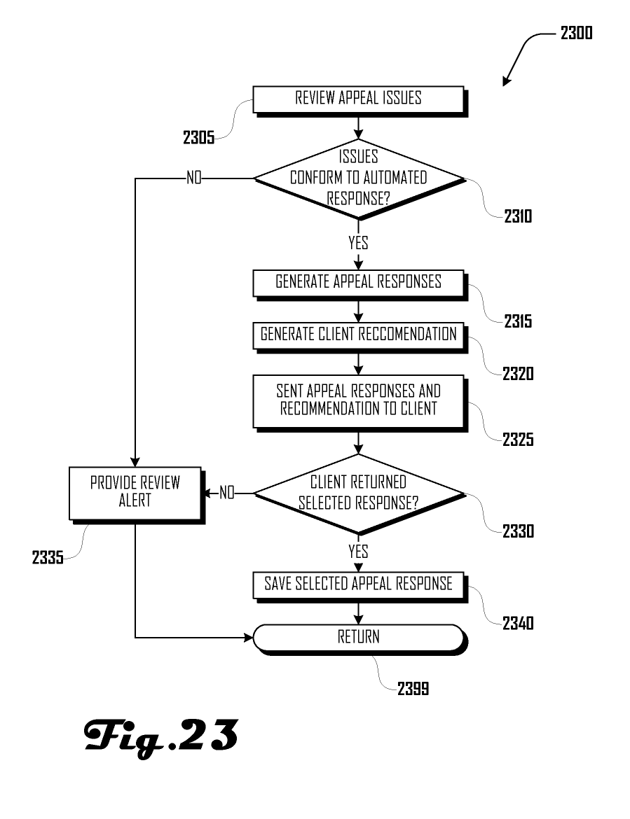

FIGS. 18 and 19 depict actions and routines that relate to responding to an appeal of the payment of a claim at a recommended rate. In various embodiments, a UCR pricing analysis and recommendation analysis results in payment for health care services that is less than an amount claimed by a provider. Accordingly, a provider may desire to appeal a payors decision to pay such an amount.

FIGS. 18 and 19 are diagrams illustrating the actions taken by an admin server 200, an appellant device 150, and a user device 110 in accordance with various embodiments. The actions begin where an appeal is obtained 1805 and a determination is made whether appeal is timely 1810. For example, an appeal process may have maximum time periods within which a party may appeal a UCR re-pricing. Accordingly, in various embodiments, a determination can be made whether an appeal conforms to such appeal timelines and is timely.

Returning to the actions, an untimely appeal waiver is generated 1815 and an untimely appeal rejection is generated 1820. An untimely appeal notification is sent 1825 to the user device 110, the untimely appeal waiver is sent 1830 to the user device 110, and the untimely appeal rejection is sent 1835 to the user device 110.

For example, if a determination is made that an appeal is not timely, then two possible responses may be to waive the untimely receipt of appeal and thereby allow the appeal to proceed as if timely received, or reject the untimely appeal as being untimely and thereby oppose the appeal. In some embodiments, there may be one or more possible responses to an appeal that is not timely. In various embodiments, it may be desirable to provide a user with a plurality of documents that the user may choose to respond with so that the user may choose a response and accordingly choose a document to respond with.

Returning to the steps, an untimely appeal rejection is selected 1840, and an executed version of the untimely appeal rejection is sent 1845 to the admin server 200 and sent 150 to the appellant device 150. For example, one of the untimely appeal waiver and untimely appeal rejection may be selected and executed by a user, and the executed document can then be sent 1945, 1850 to both the appellant device 150 and the admin server 200.

Alternatively, as depicted in FIG. 19, a user may also select 1940 an untimely appeal waiver and the untimely appeal waiver can be sent 1945 to the admin server 200 and sent 1950 to the appellant device 150.

FIGS. 20 and 21 depict actions taken by an admin server 200 an appellant device 150, and a user device 110 in accordance with various embodiments. The actions begin where an appeal is obtained 2005 and a determination is made whether appeal is timely 2010. For example, an appeal process may have maximum time periods within which a party may appeal a UCR re-pricing. Accordingly, in various embodiments, a determination can be made whether an appeal conforms to such appeal timelines.

Appeal issues are then reviewed 2015 and appeal affirmation response is generated 2020, an appeal reversal response is generated 2025, and user recommendation is generated 2030. For example, in some embodiments, an appeal affirmation response may be a response to an appeal wherein one or more issues of an appeal are affirmed, conceded, or admitted. Additionally, an appeal reversal response may be a response to an appeal wherein one or more issue of an appeal is rejected or denied.

The user recommendation is sent 2035 to the user device 110, the appeal reversal response is sent 2040 to the user device 110, and the appeal affirmation response is sent 2045 to the user device 110. As shown in FIG. 20, the appeal reversal response may be selected 2050 and an executed version of the appeal reversal response may be sent 2055 to the admin device 200 and sent 2060 to the appellant device 150.

Alternatively, as depicted in FIG. 21 an appeal affirmation response may be selected 2150, and an executed version of the appeal affirmation response may be sent 2155 to the admin server 200 and sent 2160 to the appellant device 150.

FIG. 22 depicts an automated appeal assessment and response routine 2200 in accordance with various embodiments. The automated appeal assessment and response routine 2200 begins in block 2205 where an appeal is obtained and in block 2210 and in decision block 2210 a determination is made whether the appeal is timely.

If the appeal is determined to be timely, then the automated appeal assessment and response routine 2200 continues to subroutine 2300, where appeal issues are reviewed. The automated appeal assessment and response routine 2200 continues to block 2299 where the automated appeal assessment and response routine 2200 is done.

However, if the appeal is not timely, then the automated appeal assessment and response routine 2200 continues to block 2215, where a late appeal notice is formatted, and in block 2220 the late appeal notice is sent to the client. In decision block 2225, a determination is made whether the client has waived the untimely appeal receipt.

In some embodiments, the client may also be sent various responses to an untimely appeal, which may include waiver of the receipt of such an untimely appeal, denial of the appeal based on untimely receipt, and the like. In other embodiments, the determination made in block 2225 may be based on whether a client provides an executed version of a provided response to an untimely appeal.

Returning to the automated appeal assessment and response routine 2200, wherein a client does not waive an untimely appeal, the appeal acceptance status is saved in block 2230, and the automated appeal assessment and response routine 2200 continues to sub-routine 2300 where appeal issues are reviewed. The automated appeal assessment and response routine 2200 continues to block 2299 where the automated appeal assessment and response routine 2200 is done.

However, if the client does waive the untimely receipt of the appeal, the appeal rejection status is saved in block 2254 and the automated appeal assessment and response routine 2200 continues to block 2299 where it is done.

For example, in various embodiments, where it is determined that an appeal is untimely, a client may be given a choice as to whether to allow the appeal by waiving untimely receipt, or to reject the appeal based on untimely receipt. The client may then provide an executed version of documents that accept or reject an appeal, and such documents may be used to determine if the client has chosen to accept or deny the appeal.

FIG. 23 is an automated appeal issue analysis subroutine 2300 in accordance with various embodiments. The appeal issue analysis subroutine 2300 begins in block 2305 where appeal issues are reviewed. In decision block 3210, a determination is made whether issues conform to automated response. If issues do not conform to automated response, the appeal issue analysis subroutine 2300 continues to block 2335 where a review alert is provided. The appeal issue analysis subroutine 2300 continues to block 2399 where the appeal issue analysis subroutine 2300 returns to its calling routine. For example, some appeals may comprise issues that need to be reviewed by an attorney before a response can be provided. Additionally, some appeals may not be in a format that allows for appeal issues to be identified, so it may be necessary to have appeals issues identified by a human operator.

However, if issues conform to an automated response the issue analysis subroutine 2300 continues to block 2315 where appeal responses are generated, and in block 2320 a client recommendation is generated. For example, in some embodiments, appeal issues can be identified by key word search, key phrase search, and the like. In other embodiments, an appeal may be in a form that is standardized and an automated response to such a standardized appeal can be generated.

In decision block 2330 a determination is made whether the client has returned a selected response. If the client has not returned a selected response, the issue analysis subroutine 2300 continues to block 2335 where a review alert is provided, and the issue analysis subroutine 2300 continues to block 2399 where the subroutine returns to its calling routine.

However, if the client has returned a selected response, the selected appeal response is saved in block 2340 and the issue analysis subroutine 2300 continues to block 2399 where the subroutine returns to its calling routine. For example, a client may be provided with one or more recommended responses to an appeal, and the client may select one or more recommended responses. The client may return an executed copy of the response, which may also be sent to an appellant, and the like.

Additionally, although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. While various embodiments have been illustrated and described, as noted above, many changes can be made without departing from the spirit and scope of the embodiments described herein.

1. A computer implemented method of health benefits claim intake and rating comprising:
obtaining client intake data associated with a client profile comprising client location,
health care provider,
present treatment cost, and
client risk tolerance;
obtaining program score criteria, wherein said program score criteria correspond to a plurality of hierarchically ranked payment programs and said program score criteria correspond to client characteristics that make a client eligible for one or more of said hierarchically ranked payment programs;
comparing said client intake data to said program score criteria;
generating a score based on said comparing, which indicates whether said client profile is eligible for one or more of said hierarchically ranked payment programs; and
presenting a program recommendation based on said score.

2. The method of claim 1, wherein said plurality of hierarchically ranked payment programs comprises a UCR program.

3. The method of claim 2, wherein said UCR program is hierarchically ranked first.

4. The method of claim 3, wherein said score indicates whether said client profile is eligible for said UCR program

5. The method of claim 1, wherein said client risk tolerance correlates to risk tolerance of an appeal.

6. The method of claim 1, wherein presenting said program recommendation comprises formatting an option recommendation letter.

7. A computer implemented method of health benefits claim intake and rating comprising:
obtaining client intake data associated with a client profile comprising
client location,
health care provider,
present treatment cost, and
client risk tolerance;
obtaining program score criteria, wherein said program score criteria correspond to a plurality of payment programs and said program score criteria correspond to client characteristics that make a client eligible for the hierarchically ranked payment programs;
comparing said client intake data to said program score criteria;
generating a score for each of said plurality of payment programs based on said comparing, which indicates whether said client profile is eligible for any of said payment programs; and
presenting a program recommendation based on said score for each of said plurality of payment programs.

8. The method of claim 7, wherein said plurality of hierarchically ranked dialysis payment programs comprises a UCR analysis program.

9. The method of claim 7, wherein said client risk tolerance correlates to risk tolerance of an appeal.

10. The method of claim 1, wherein presenting said program recommendation comprises formatting an option recommendation letter.

11. A computer implemented method of health benefits claim analysis comprising:
obtaining client treatment payment data associated with a client profile comprising:
a client treatment center location,
a client treatment provider, and
a client treatment payment history,
obtaining government treatment reimbursement data,
obtaining treatment blend parameters that corresponds to the portion of reimbursement obtained by a provider from government and commercial reimbursement sources;
selecting a set of provider treatment centers based on proximity to said client treatment center location, and includes said client dialysis treatment center;
determining, an overall average treatment price of said set of provider treatment centers based on said treatment blend parameters;
selecting a client treatment re-pricing based on said overall average treatment price, wherein said client treatment re-pricing is greater than said overall average treatment price.

12. The method of claim 10 further comprising:
obtaining, for each selected provider treatment center, a commercial treatment pricing
calculating, for each selected provider treatment center, a government dialysis treatment pricing portion and a commercial treatment pricing portion, and
calculating, for each selected provider treatment center, a center average treatment price based on said government treatment pricing portion and said commercial treatment pricing portion,
wherein said overall average treatment price is based on said center average treatment price calculated for each selected provider treatment center.

13. The method of claim 10 further comprising:
obtaining an average provider treatment payment correlating said client treatment provider,
wherein said selecting a client treatment re-pricing is further based on said average provider treatment payment and wherein said client treatment re-pricing is greater than said selected average provider treatment payment.

14. The method of claim 13, wherein said average provider treatment payment is obtained via public records corresponding to said client dialysis treatment provider.

15. The method of claim 14, wherein said average provider treatment payment is obtained via securities records corresponding to said client treatment provider.

16. The method of claim 15, wherein said average provider treatment payment is obtained via SEC 10Q securities records corresponding to said client treatment provider.

17. The method of claim 10 wherein said government treatment reimbursement data is Medicare treatment reimbursement data.

18. The method of claim 10 further comprising presenting a reprising explanation matrix.

19. A computer implemented method of providing an automated health benefits claim determination response:
obtaining a set of appeal responses corresponding to a health benefits claim determination appeal issue;
obtaining an appeal comprising an appeal date and one or more health benefits claim determination appeal issues;
determining whether said health benefits claim determination appeal is timely based on said appeal date;
identifying said at least one health benefits claim determination appeal issue;
formatting a response to said health benefits claim determination appeal based on said determining and said identifying.

20. The method of claim 10 further comprising presenting a health benefits claim determination explanation matrix.
